(19) United States
(12) Patent Application Publication
(10) Pub. No.: US 2002/0049673 A1
(43) Pub. Date: Apr. 25, 2002

(54) Bad check and unpaid bill collection system

(76) Inventor: Ramiz G. Sheena, West Bloomfield, MI (US)

Correspondence Address: John G. Posa, Gifford, Krass, Groh et al, Suite 400, 280 N. Old Woodward Ave., Birmingham, MI, 48009, US

(21) Appl. No.: 09/968,172

(22) Filed: Oct. 1, 2001

Related U.S. Application Data
(60) Provisional application No. 60/236,963, filed on Sep. 29, 2000.

(51) Int. Cl. G06F 17/60

(52) U.S. Cl. 705/40

(57) ABSTRACT

The present invention relates to a system used to protect persons, stores, banks and other institutions who cash checks, whether of one party or two party. The system requires that a person authorized the person who he is presenting his check to to post the presenter of the check's name and other information on it an Internet website if any problems occur with the check. The posted information may include a person's name, driver's license number and other information. The information can later be accessed by institutions or other who pay a periodic fee for service. Revenues will also be generated by the person who is listed at the website in order to get their name removed.

### REFERENCE TO RELATED APPLICATION

This application claims priority from U.S. provisional patent application Ser. No. 60/236,963, filed Sep. 29, 2000, the entire contents of which is incorporated herein by reference.

### FIELD OF THE INVENTION

This invention relates generally to monetary transactions and, in particular, to a method of protecting against bad check and unpaid debts.

### BACKGROUND OF THE INVENTION

Currently both first party and second party checks may be cashed at a variety of locations, including banks, stores, etc. In the case of a one-party check, it is made out for the amount and signed without having to endorse it. In the case of a two-party check, it is made out to a separate party and cashed.

Due to the potential for abuse, various check-verification systems have been proposed, some of which have been implemented. U.S. Pat. No. 5,679,938, for example, describes a check acceptance system that provides interactive authorizations and off-line terminal approvals. A merchant uses an interactive transaction terminal to communicate with a check acceptance service's authorization host computer. The terminal includes an electronic check reader and a magnetic stripe reader for reading magnetic stripe drivers licenses. The terminal acquires transaction data associated with a pending check transaction. The transaction data is analyzed to determine whether the transaction can be approved by the terminal. If so, an approval code is generated and a transaction packet including the transaction data and terminal approval code are stored in the terminal until subsequent communication with the host computer. If the pending transaction is not approved by the terminal, the transaction data is transmitted to the host computer. The host computer applies a risk scoring algorithm to the data to determine whether the transaction should be approved, declined, or whether additional information is needed. If the transaction is approved or declined, a response packet including authorization indicia is transmitted to the terminal. If additional data is needed, the host computer transmits prompts to the terminal. The terminal displays the prompts and the merchant enters the requested data into the terminal. A new transaction packet including the original transaction data and the additional requested data is transmitted to the host computer, where it is approved or declined.

U.S. Pat. No. 5,594,226 is directed to apparatus for automatically accessing and verifying checking account status based on information contained in a bar code printed on a check, travelers check or money order. A bar code scanner reads the information contained in the bar code and, based on that information, determines a bank code and an account code. Based on the bank code or account code, a proper bank, travelers check company or money order company is automatically contacted. Checking, travelers check or money order account information is then transmitted to the proper bank, travelers check company or money order company. Account status information is received from the bank, travelers check company or money order company and displayed on the merchant's terminal. A receipt is printed with a bar code matching information on the check, travelers check or money order.

Although systems of the type just described may be beneficial in certain circumstances, the need remains for alternative methods. In particular, existing systems tend to either be privately implemented or put into effect before or during an attempted fraudulent transaction. The need remains for a system that corrects for bogus transfers after the fact.

### SUMMARY OF THE INVENTION

This invention is used to protect persons, stores, banks and other institutions who cash checks, whether of the one-party or two-party type. Broadly, if there are any problems with the check, the person presenting the check authorizes that their name and other information be posted on an Internet web site. Such authorization may use the same signature supplied to endorse the check, or a separate authorization area may be used. The posted information may include the person's name, when they came into the bank or store, driver's license number, and the amount of the check. A fingerprint is also preferably taken to allow one to know the true identity of the individual.

In the future, when a check is presented, this information will be accessed to determine whether or not to honor the check. Persons or institutions may be required to pay a small amount to put the information on the website, or to gain subsequent access. Revenues will also be generated by the person who is listed at the site in order to get their removed.

The name may be remove by an Internet service provider or, alternatively, the bad check writer may return to the store/bank where the bad check was passed. This invention is also applicable to unpaid bills debt collection, and will save companies time by having an added description on their forms. This description will be worded to tell clients/customers that if they fail to make payment as services are rendered, the company will be allowed to post their name on an Internet website for unpaid debt. This will be beneficial to dealerships, furniture stores, credit card companies, department stores, mortgage/loan companies, etc.

### BRIEF DESCRIPTION OF THE DRAWINGS

FIG. 1 is a flow diagram which illustrates important activities according to the invention; and

FIG. 2 shows the back of a check with a contract associated with public posting authority.

### DETAILED DESCRIPTION OF THE INVENTION

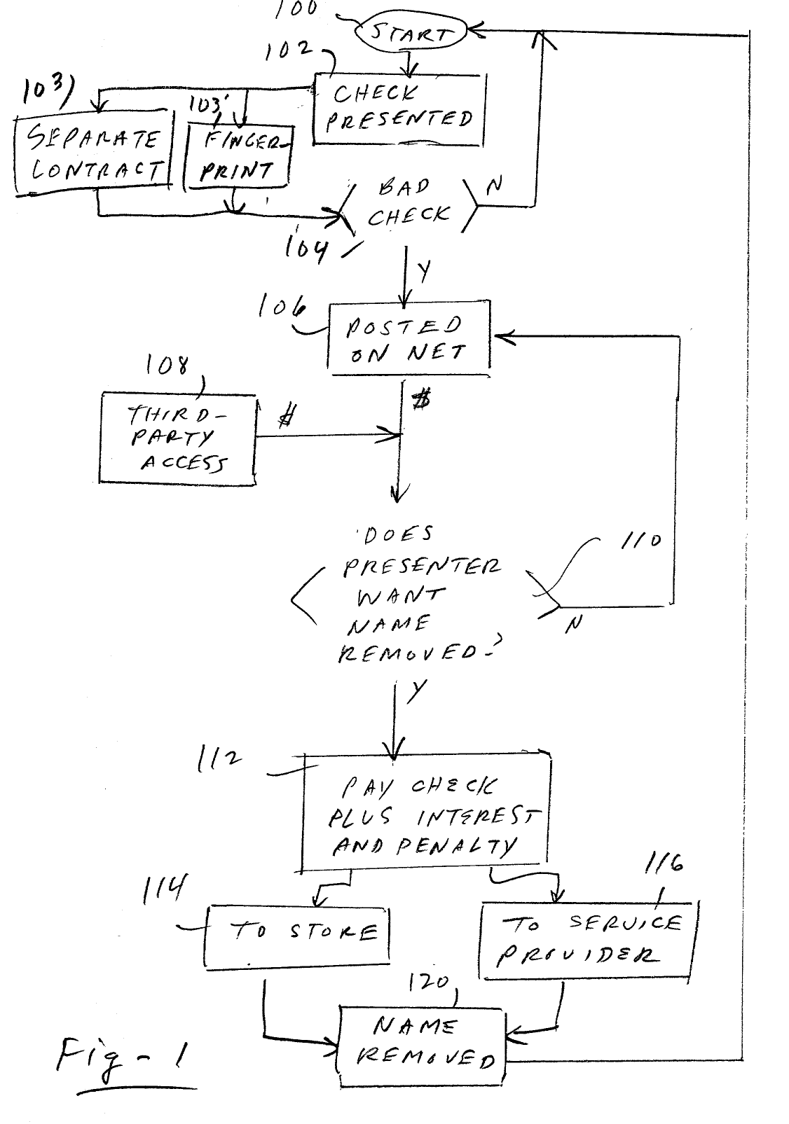

Reference is now made to the drawings, wherein FIG. 1 depicts a flow diagram which illustrates important activities according to the invention. The process is initiated at 100, with a check being presented at 102. In conjunction with the presentation, the presenter has to sign a separate contract 103, and a fingerprint may be taken at 103′ to verify the true identity of the individual.

If the check is bad (104), the individual presenting the check authorizes their name and other information to be posted on an Internet web site at block 106. Such authorization may use the same signature supplied to endorse the check, or a separate authorization area may be used. In any case, the presenter agrees that if there is a problem or insufficient finds and the check is returned, they get listed at the website. In the preferred embodiment, the posted information includes the person's name, when they came into the bank or store, driver's license number, and the amount of the check.

Using the inventive system, when a check is presented in the future, this information may be accessed by a third party 108 (or the original store or bank) and, if the presenter's name is listed, the institution may decide whether or not to honor the check. In terms of revenue generation, the institution may be required to pay a small amount to access the website whether to list a particular individual or check up on a new presenter. In the preferred embodiment the institution will open an account, and will automatically be debited a micropayment for each check posted.

Revenues will also be generated by the person who is listed at the site to have their name removed (110, 112). Assume that a person passed a bad check for $100. They could send an amount to the bad check website for $100, plus penalty and interest, plus the fee that the bad check site provider is charging for the service. The service has the name and address of the person who put the bad check writer on their list because they have preferably opened up an account. The service provider keeps the penalty and interest and they send the $100, plus service charge for non-sufficient funds to the institution who posted it in the first place. And then the name of the bad check writer is removed. There should not be any problems with a discrepancy in the amount, unless the amount was posted incorrectly in the first place.

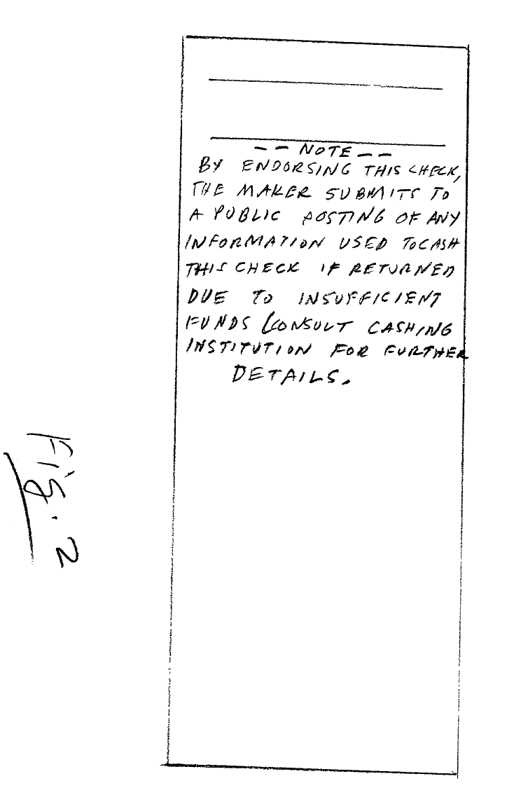

Although the name will typically be removed by a service provider (116), as an alternative, the bad check writer may return to the store where the bad check was passed (114). Information as to penalty and interest may be obtained by the bad check writer from the same web site. As an option, the invention may require the presenter to make a check out to cash in an amount equal to the purchase price, thereby requiring an endorsement. If there is a problem endorsing in the area prescribed for such purpose, the check may be printed with a special area on it, using a stamp, for example, that goes outside of the endorsement area that they have sign (FIG. 2). Contacting check-making companies to redesign the endorsement area of the check to minimize paperwork and have endorsers sign contract automatically when trying to cash their check.

It should also be possible to give an establishment a credit card number in order to take care of the amounts that are posted on the site. There will also preferably be posted a hierarchy of how bad people are from red alert, down to less violations. If there is a fraudulent check or something like that, you might be able to have it automatically dial the police so that while the customer is still in the store, the police will show up.

This invention is also applicable to unpaid bills debt collection. Currently, when a company has an account with unpaid collections they hire a bill collector to attempt to collect payment. If the client/customer does not payment the bill collector receives a percentage and the rest is sent to the company to erase the debt on that individual's account.

When a individual fills out a form above the signature section will be a box allowing the company to take action if payment is not made, and when the individual signs the form he/she is bound to that agreement. An Internet website will be set up and unpaid bills will be posted with that individual's name. This will force the individual to pay to save face and embarrassment. An individual can pay through the site or at the place where services were rendered.

I claim:

1. A bad check and unpaid bills protection method, comprising the steps of:
posting information about bad checks, bad check presenters, or unpaid bills on a web site, enabling an establishment to check the site before cashing a check or otherwise extending further credit; and
allowing the information to be removed from the site through the payment of a fee.
